(19) United States
(12) Patent Application Publication
(10) Pub. No.: US 2003/0051597 A1
(43) Pub. Date: Mar. 20, 2003

(54) Area denial

(76) Inventor: James Michael O'Dwyer, Queensland (AU)

Correspondence Address: FINNEGAN, HENDERSON, FARABOW, GARRETT &, DUNNER LLP, 1300 I STREET, NW, WASHINGTON, DC, 20006, US

(21) Appl. No.: 10/168,179

(22) PCT Filed: Dec. 20, 2000
(86) PCT No.: PCT/AU00/01572

(30) Foreign Application Priority Data
Dec. 20, 1999 (AU) PQ 4787

(51) Int. Cl. B64D 1/04

(52) U.S. Cl. 89/1.11; 42/76.01

(57) ABSTRACT

A method of denying access to a designated area (10) wherein said method includes monitoring designated area (10) to detect the presence of an intruder, and initiating an attack on said intruder wherein said attack includes discharging projectiles (15) from a barrel assembly (13). Barrel assembly (13) includes one or more barrels (16), a plurality of projectiles (15) axially disposed within each barrel (16) for operative sealing engagement with the bore of the barrel (16), and discrete propellant charges for propelling respective projectiles (15) sequentially through the muzzle of the barrel (16). The monitoring can be performed remotely from designated area (10) by sensing means (14), or on-site by way of sensors (11) distributed within designated area (10). The intruder can be military personnel such as one or more infantrymen, or a manned or unmanned vehicle such as an armoured car or tank.

This invention relates to area denial. In particular this invention relates to area denial for denying access to a designated area that may be readily deployed and removed. In one application, this invention relates to holding ground in the face of an invading force.

Conventionally denying access to a designated area is by placement of concealed land mines throughout a designated area. These land mines are normally placed randomly throughout a designated area. This form of area denial has been widely used in the past and unfortunately it has resulted in many past war zones remaining mined long after peace has returned to the zone. This often renders good fertile land unusable and causes widespread unintentional injury to civilians.

Furthermore areas that are mined effectively prevent all access to the mined zone. Mined areas deny passage to friends and foe alike, as well as wildlife. Typically, areas are mined so that the likelihood of personnel being injured is high. This acts as an effective deterrent to ingress upon the mined zone. To this end, mines are not arranged on any fixed grid spacing even though this would facilitate relatively simple clearing of the mines. Such fixed grid spacings would also facilitate unauthorised passage across the zone clear of the mines.

In order to breach a minefield, mines may be cleared from a relatively narrow path through a mined zone and render the minefield ineffective.

We have now found a method of denying access to a designated area whereby the need for a fixed minefield is removed. Accordingly there is provided a method of denying access to a designated area wherein said method includes monitoring the designated area to detect the presence of an intruder, and initiating an attack on said intruder wherein said attack includes discharging projectiles from a barrel assembly, said barrel assembly having a barrel, a plurality of projectiles axially disposed within the barrel for operative sealing engagement with the bore of the barrel, and discrete propellant charges for propelling respective projectiles sequentially through the muzzle of the barrel.

In another aspect there is provided an area denial system including a monitor for monitoring the designated area to detect the presence of an intruder, and ordinance for initiating an attack on said intruder wherein said ordinance includes a projectile launching apparatus for discharging projectiles from a barrel assembly, said barrel assembly having a barrel, a plurality of projectiles axially disposed within the barrel for operative sealing engagement with the bore of the barrel, and discrete propellant charges for propelling respective projectiles sequentially through the muzzle of the barrel.

An intruder may be in any of a number of forms and may include a plurality of intruders. An intruder may be military personnel, in the form of an infantryman or foot soldier. Alternatively, the intruder may be a manned or unmanned vehicle such as an armoured car or tank.

The monitor may be any convenient monitor and may include on-site sensors which may be employed in the designated area or it may include sensors deployed remote from the designated area. Alternatively, the monitors may include both onsite and remote sensors. The monitor or monitors may include visual, or infra-red detectors, radar and seismic sensors or other suitable sensors that may be selected dependent upon the nature of intruders to be denied access from the designated area. The monitors may also provide a visual display of the monitored designated area. In a preferred configuration a forward operative operates the ordinance that is initiated to launch an attack on the intruder. Alternatively, the monitor may be in direct communication with the ordinance such that an attack may be automatically triggered. Preferably, even with an automated system a forward operative manually override the automated system if desired, to enable manual control or selection of the defence means to be utilised.

Preferably the defence means is adapted for inconspicuous placement, however in some applications conspicuous defence means may be utilised as a deterrent. The defence means may be any suitable arrangement of conventional weapons such as machine guns, grenade and rocket launchers or cannons.

Barrel assemblies including a barrel; a plurality of projectiles axially disposed within the barrel for operative sealing engagement with the bore of the barrel, and discrete propellant charges for propelling respective projectiles sequentially through the muzzle of the barrel discharge projectiles to attack the intruder. Such barrel assemblies are described in International Patent Application Nos. PCT/AU94/00124, PCT/AU96/00459 and PCT/AU97/00713.

The projectile may be round, conventionally shaped or dart-like and the fins thereof may be off-set to generate a stabilising spin as the dart is propelled from a barrel which may be a smooth-bored barrel.

The projectile charge may be form as a solid block to operatively space the projectiles in the barrel or the propellant charge may be encased in metal or other rigid case which may include an embedded primer having external contact means adapted for contacting an pre-positioned electrical contact associated with the barrel. For example the primer could be provided with a sprung contact which may be retracted to enable insertion of the cased charge into the barrel and to spring out into a barrel aperture upon alignment with that aperture for operative contact with its mating barrel contact. If desired the outer case may be consumable or may chemically assist the propellant burn. Furthermore an assembly of stacked and bonded or separate cased charges and projectiles may be provide for reloading a barrel.

Each projectile may include a projectile head and extension means for at least partly defining a propellant space. The extension means may include a spacer assembly which extends rearwardly from the projectile head and abuts an adjacent projectile assembly.

The spacer assembly may extend through the propellant space and the projectile head whereby compressive loads are transmitted directly through abutting adjacent spacer assemblies. In such configurations, the spacer assembly may add support to the extension means which may be a thin cylindrical rear portion of the projectile head. Furthermore the extension means may form an operative sealing contact with the bore of the barrel to prevent burn leakage past the projectile head.

The spacer assembly may include a rigid collar which extends outwardly to engage a thin cylindrical rear portion of the malleable projectile head inoperative sealing contact with the bore of the barrel such that axially compressive loads are transmitted directly between spacer assemblies thereby avoiding deformation of the malleable projectile head.

Complementary wedging surfaces may be disposed on the spacer assembly and projectile head respectively whereby the projectile head is urged into engagement with the bore of the barrel in response to relative axial compression between the spacer means and the projectile head. In such arrangement the projectile head and spacer assembly may be loaded into the barrel and there after an axial displacement is caused to ensure good sealing between the projectile head and barrel. Suitably the extension means is urged into engagement with the bore of the barrel.

The projectile head may define a tapered aperture at its rearward end into which is received a complementary tapered spigot disposed on the leading end of the spacer assembly, wherein relative axial movement between the projectile head and the complementary tapered spigot causes a radially expanding force to be applied to the projectile head.

The barrel may be non-metallic and the bore of the barrel may include recesses which may fully or partly accommodate the ignition means. In this configuration the barrel houses electrical conductors which facilitate electrical communication between the control means and ignition means. This configuration may be utilised for disposable barrel assemblies which have a limited firing life and the ignition means and control wire or wires therefor can be integrally manufactured with the barrel.

A barrel assembly may alternatively include ignition apertures in the barrel and the ignition means are disposed outside the barrel and adjacent the apertures. The barrel may be surrounded by a non-metallic outer barrel which may include recesses adapted to accommodate the ignition means. The outer barrel may also house electrical conductors which facilitate electrical communication between the control means and ignition means. The outer barrel may be formed as a laminated plastics barrel which may include a printed circuit laminate for the ignition means.

The barrel assembly may have

adjacent projectiles that are separated from one another and maintained in spaced apart relationship by locating means separate from the projectiles, and

each projectile may include an expandable sealing means for forming an operative seal with the bore of the barrel. The locating means may be the propellant charge between adjacent projectiles and the sealing means suitably includes a skirt portion on each projectile which expands outwardly when subject to an in-barrel load. The in-barrel load may be applied during installation of the projectiles or after loading such as by tamping to consolidate the column of projectiles and propellant charges or may result from the firing of an outer projectile and particularly the adjacent outer projectile.

The rear end of the projectile may include a skirt about an inwardly reducing recess such as a conical recess or a part-spherical recess or the like into which the propellant charge portion extends and about which rearward movement of the projectile will result in radial expansion of the projectile skirt. This rearward movement may occur by way of compression resulting from a rearward wedging movement of the projectile along the leading portion of the propellant charge it may occur as a result of metal flow from the relatively massive leading part of the projectile to its less massive skirt portion.

Alternatively the projectile may be provided with a rearwardly divergent peripheral sealing flange or collar which is deflected outwardly into sealing engagement with the bore upon rearward movement of the projectile. Furthermore the sealing may be effected by inserting the projectiles into a heated barrel which shrinks onto respective sealing portions of the projectiles. The projectile may comprise a relatively hard mandrel portion located by the propellant charge and which cooperates with a deformable annular portion may be moulded about the mandrel to form a unitary projectile which relies on metal flow between the nose of the projectile and its tail for outward expansion about the mandrel portion into sealing engagement with the bore of the barrel.

The projectile assembly may include a rearwardly expanding anvil surface supporting a sealing collar thereabout and adapted to be radially expanded into sealing engagement with the barrel bore upon forward movement of the projectile through the barrel. In such a configuration it is preferred that the propellant charge have a cylindrical leading portion which abuts the flat end face of the projectile.

The projectiles may be adapted for seating and/or location within circumferential grooves or by annular ribs in the bore or in rifling grooves in the bore and may include a metal jacket encasing at least the outer end portion of the projectile. The projectile may be provided with contractible peripheral locating rings which extend outwardly into annular grooves in the barrel and which retract into the projectile upon firing to permit its free passage through the barrel.

The electrical ignition for sequentially igniting the propellant charges of a barrel assembly may preferably include the steps of igniting the leading propellant charge by sending an ignition signal through the stacked projectiles, and causing ignition of the leading propellant charge to arm the next propellant charge for actuation by the next ignition signal. Suitably all propellant charges inwardly from the end of a loaded barrel are disarmed by the insertion of respective insulating ruses disposed between normally closed electrical contacts.

Ignition of the propellant may be achieved electrically or ignition may utilise conventional firing pin type methods such as by using a centre-fire primer igniting the outermost projectile and controlled consequent ignition causing sequential ignition of the propellant charge of subsequent rounds. This may be achieved by controlled rearward leakage of combustion gases or controlled burning of fuse columns extending through the projectiles.

In another form the ignition is electronically controlled with respective propellant charges being associated with primers which are triggered by distinctive ignition signals. For example the primers in the stacked propellant charges may be sequenced for increasing pulse width ignition requirements whereby electronic controls may selectively send ignition pulses of increasing pulse widths to ignite the propellant charges sequentially in a selected time order. preferably however the propellant charges are ignited by a set pulse width signal and burning of the leading propellant charge arms the next propellant charge for actuation by the next emitted pulse.

Suitably in such embodiments all propellant charges inwardly from the end of a loaded barrel are disarmed by the insertion of respective insulating fuses disposed between insertion of respective insulating fuses disposed between normally closed electrical contacts, the fuses being set to burn to enable the contacts to close upon transmission of a suitable triggering signal and each insulating fuse being open to a respective leading propellant charge for ignition thereby.

A number of projectiles can be fired simultaneously, or in quick succession, or in response to repetitive manual actuation of a trigger, for example. In such arrangements the electrical signal may be carried externally of the barrel or it may be carried through the superimposed projectiles which may clip on to one another to continue the electrical circuit through the barrel, or abut in electrical contact with one another. The projectiles may carry the control circuit or they may form a circuit with the barrel.

The projectiles may be launched as direct or indirect fire and may be part of a layered defence system whereby various payloads and delivery systems may be integrated to deny access to the designated area by means dependent upon the position and nature of the intruder. The defence system may integrate with fixed “claymore” type weapons affixed to a fixed object within the designated area, such as, for example wrapt around a tree. Such claymore type weapons may preferably include barrel assemblies having a plurality of projectiles axially disposed within the barrel and operable electronically without the need for mechanical operation, such as have been described in International Patent Application Nos. PCT/AU94/00124 and PCT/AU96/00459.

Mortar boxes including a multiplicity of barrel assemblies of the type described above may include 40 mm projectiles fired directly at the target as mortar boxes of the type used herein need not be vertically inclined in their operation as the projectile and propellant are preloaded within the barrel assembly and not conventionally loaded, such as by dropping into a vertically inclined mortar.

Such a system has the advantage of being transportable and compact and thus easily concealed while providing the ability to deliver relatively large numbers of projectiles to the designated area in a very short space of time. The individual barrels may be targeted at respective monitored zones within the designated area and operated upon detecting a presence in the respective monitored zone.

The defence module can also advantageously utilise one-use disposable type electronic multi-round barrels to enable size optimization to be more easily achieved and to provide cost benefits.

The or each defence module may include electronic multi-round barrels deploying projectiles carrying different payloads. The different payloads may be carried in barrels of the same size or of different sizes.

Payloads may include video cameras for transmitting an active picture of a detected zone to a controller for identifying an intruder for selective bombing of the detected zone; illumination means such as infra red illumination means for assisting night vision or camera equipment; warning payloads which may be audio transmission equipment for warning an intruder in the detected zone; flash bangs, flares or smoke bombs. Payloads for attacking an intruder may be lethal or non-lethal, anti personnel or anti-armour payloads. Typically these payloads are provided as grenades.

In one embodiment, the barrel assemblies may be splayed relative to each other to concentrate or diffuse the fire from the mortar box dependent upon the nature and number of intruders.

The barrel assemblies may be mounted on aircraft over passing the designated area and the monitor may provide a visual display of the zones within the designated area that have been the subject of attack from the barrel assemblies and thereby allow the aircraft to launch subsequent attacks on the remainder of the designated area. Alternatively, the monitor may permit zones within the designated area to be avoided such that either the quantity of munitions deployed or the risk of injury to friendly troops is minimised.

In another embodiment of the present invention the barrel assemblies may be used to deploy mobile mines, such as the type used in self healing minefields. In this embodiment, a minefield may be quickly deployed and replenished, as the need may be.

In another embodiment fixed barrel assemblies embedded within the designated area may be employed to launch air burst grenades once the monitor senses an intruder within the designated area.

In order that this invention may be more readily understood and put into practical effect, reference will now be made to the accompanying drawings which illustrate typical embodiments of the invention wherein:—

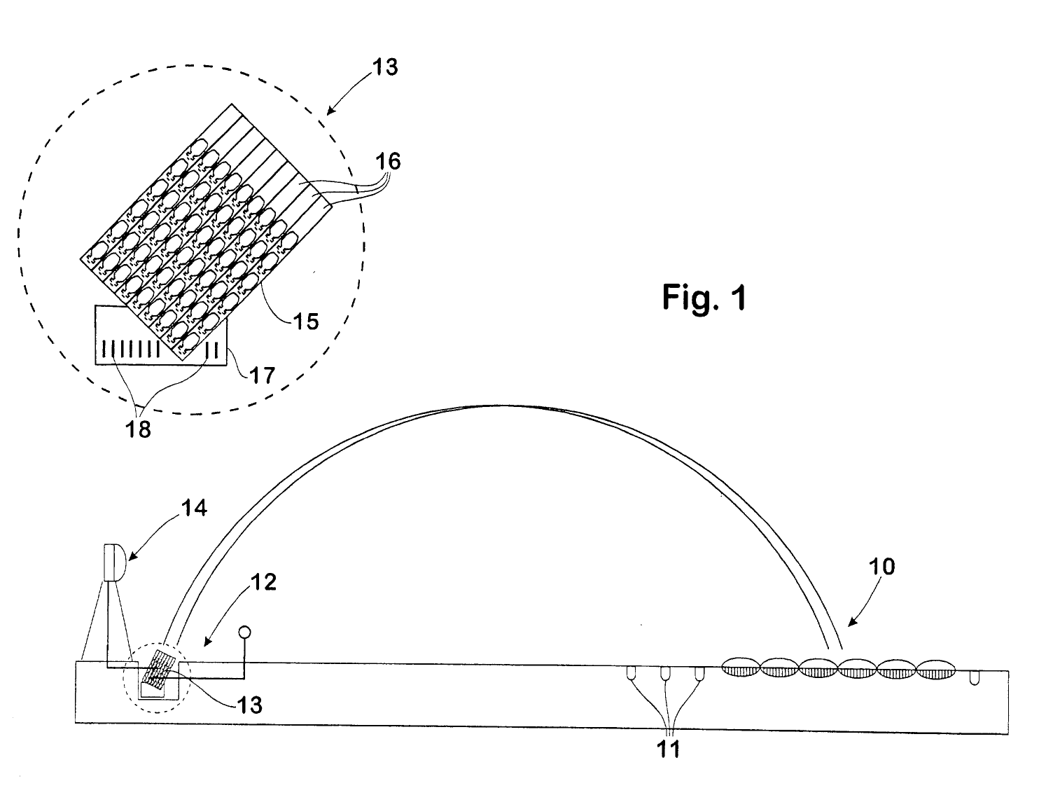

FIG. 1 is a diagrammatic layout of a typical installation;

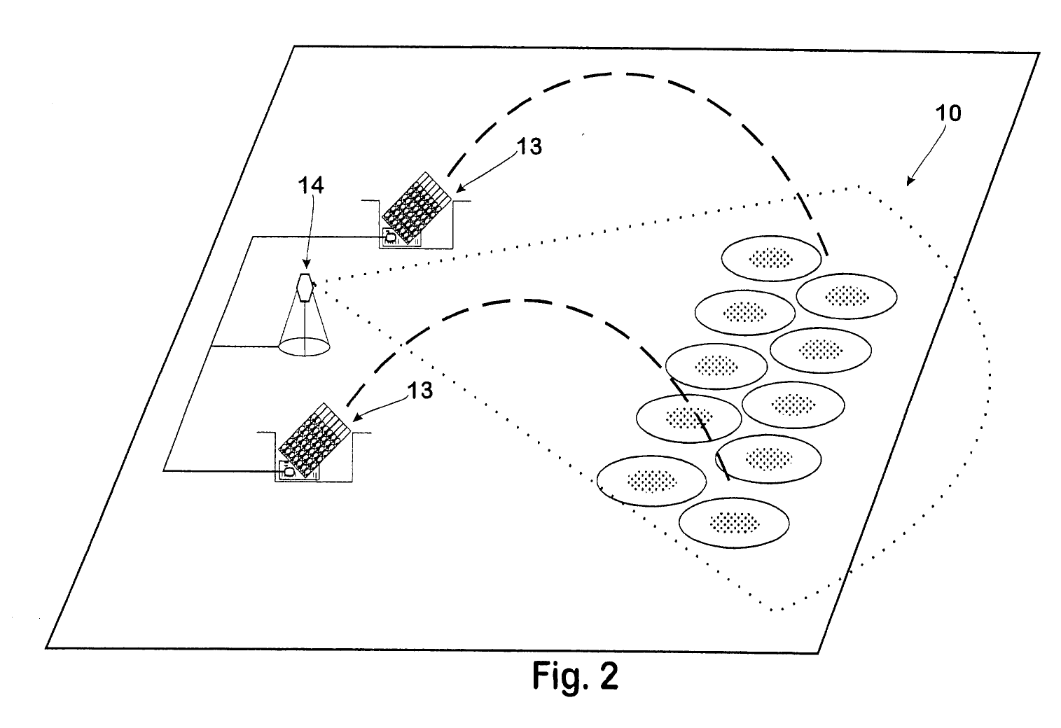

FIG. 2 provides a diagrammatic perspective view of the embodiment illustrated in FIG. 1;

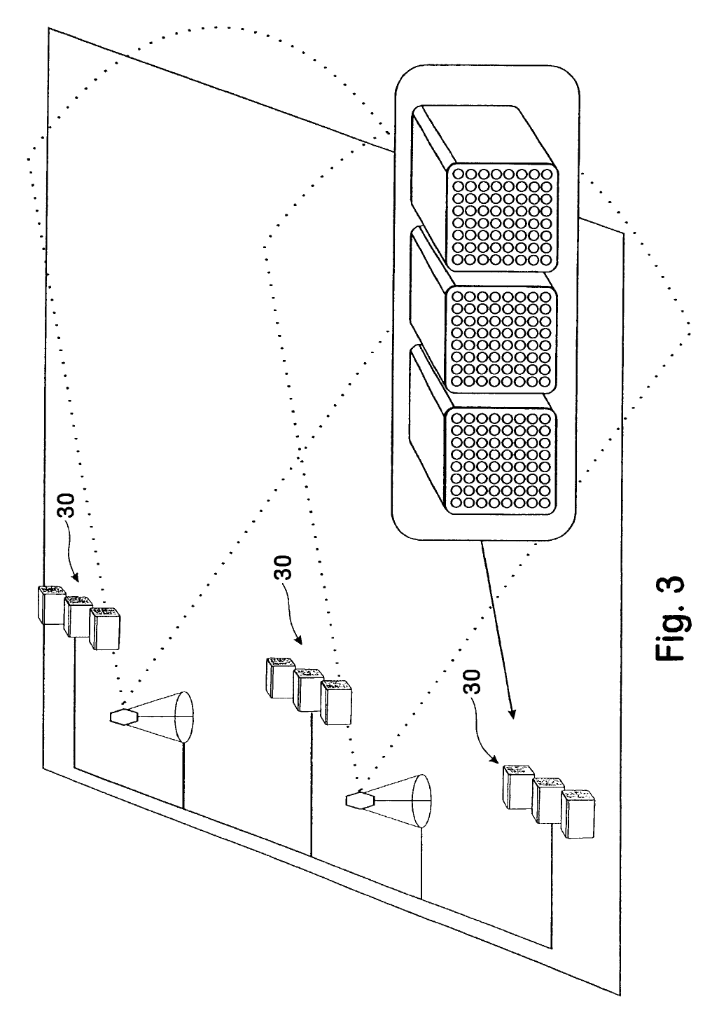

FIG. 3 is a diagrammatic perspective view of an alternate layout;

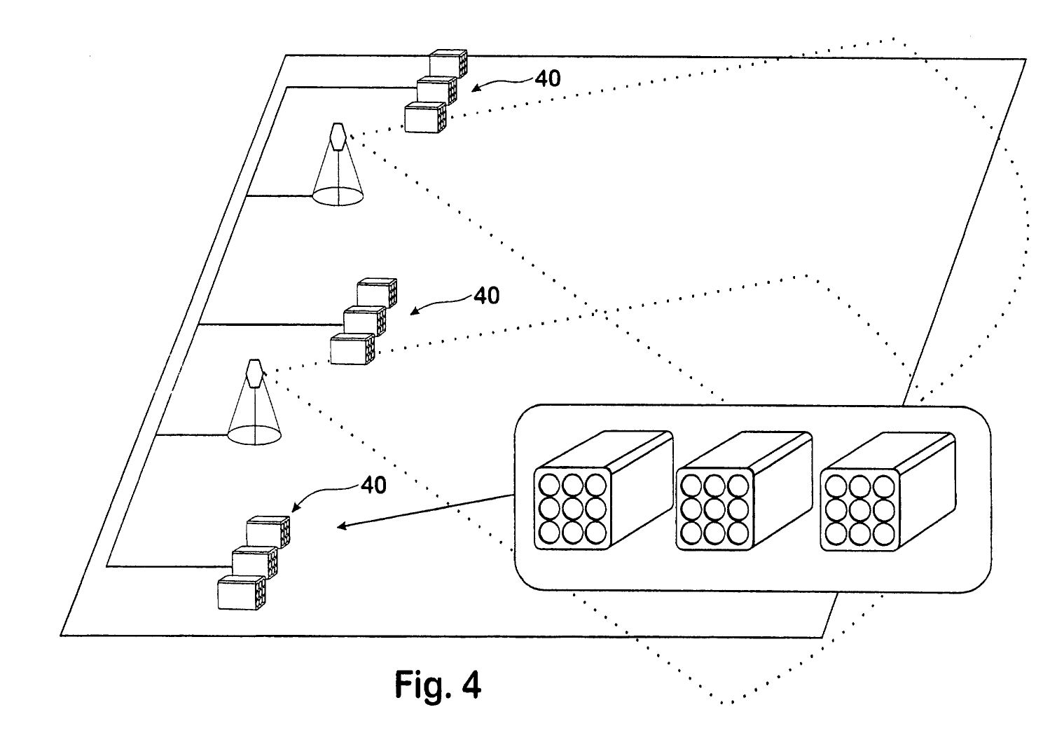

FIG. 4 is a view which is similar to FIG. 3 but illustrates alternate forms of defence means;

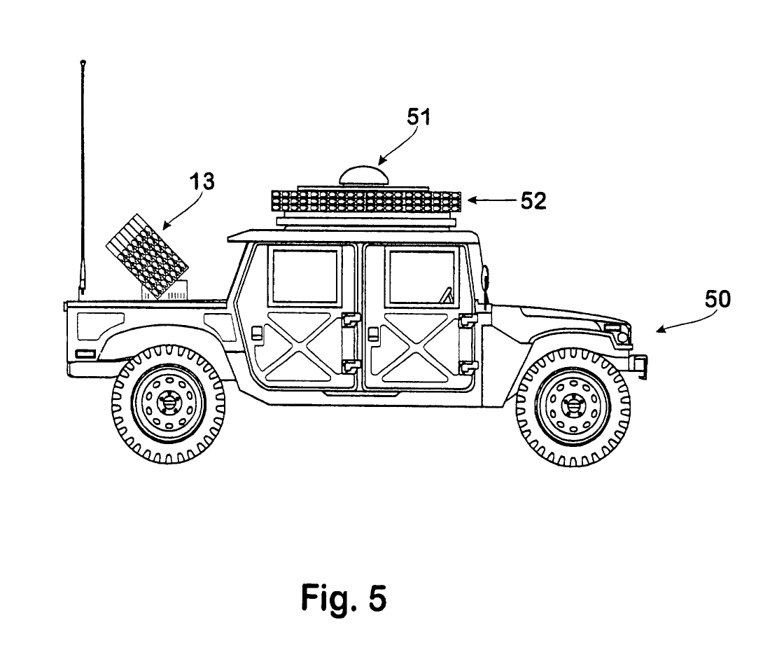

FIG. 5 illustrates a further embodiment of the invention in which the defence means and the remote monitoring means are deployed in a vehicle;

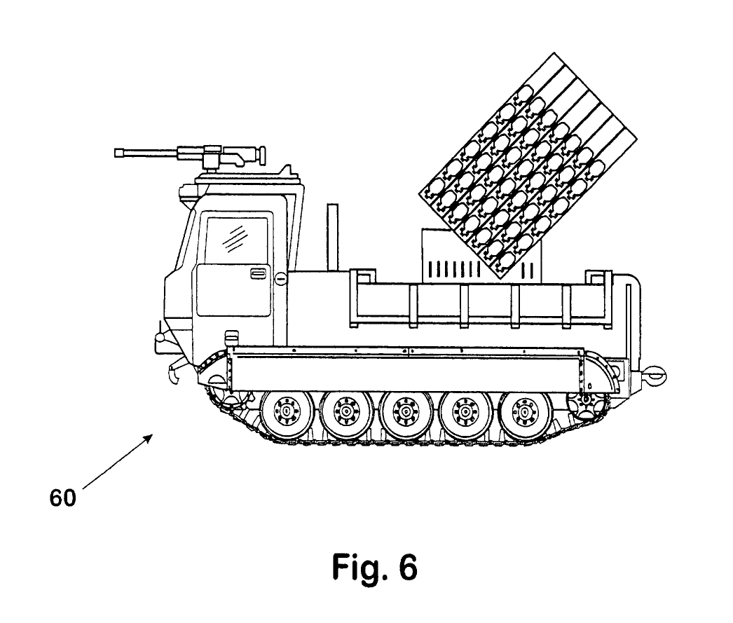

FIG. 6 illustrates an alternate form of vehicle deployment;

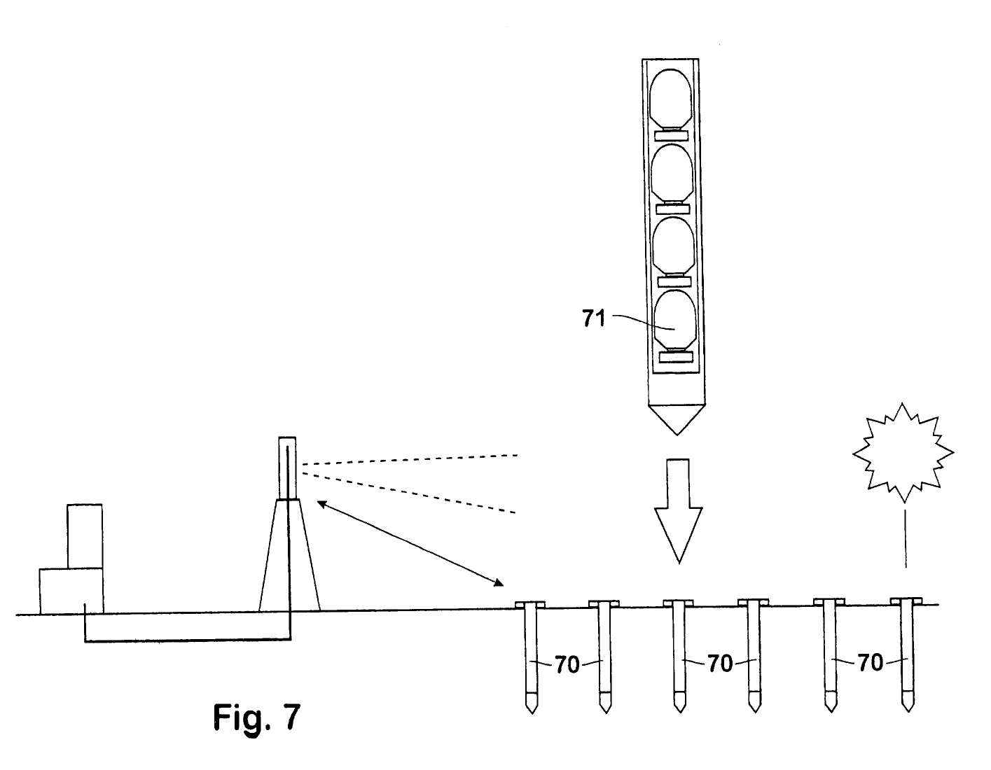

FIG. 7 illustrates an installation in which the defence means is provided with permanent in-ground mountings with reloadable inserts;

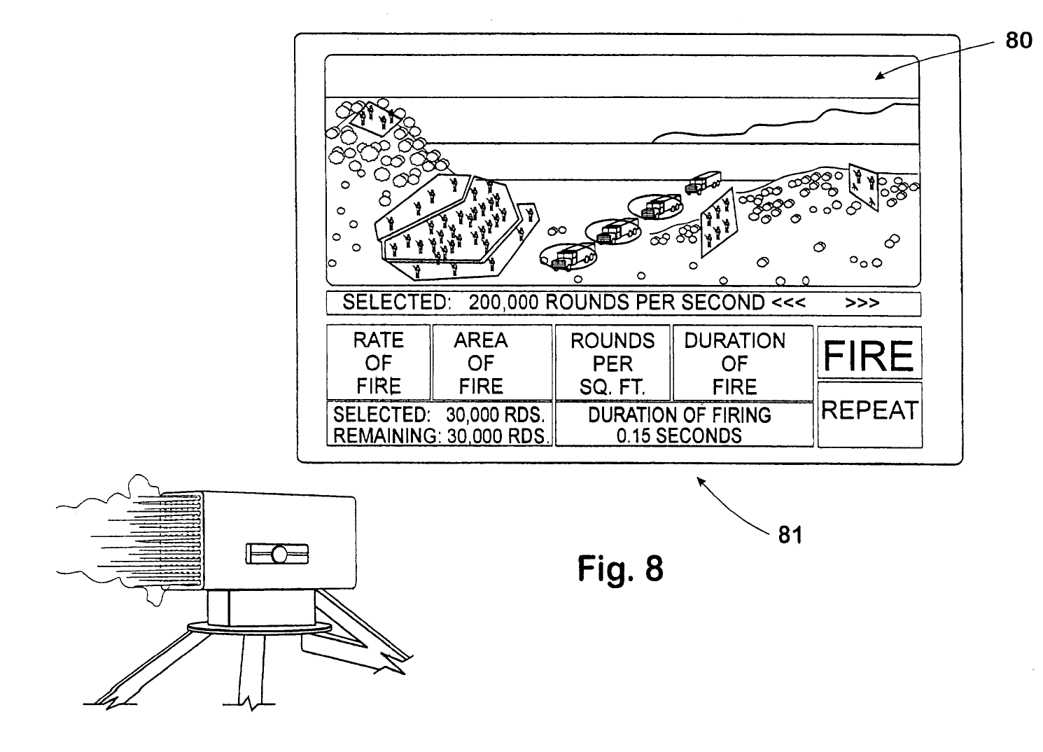

FIG. 8 illustrates a remote visual display monitor for a manual override control of the said area denial means;

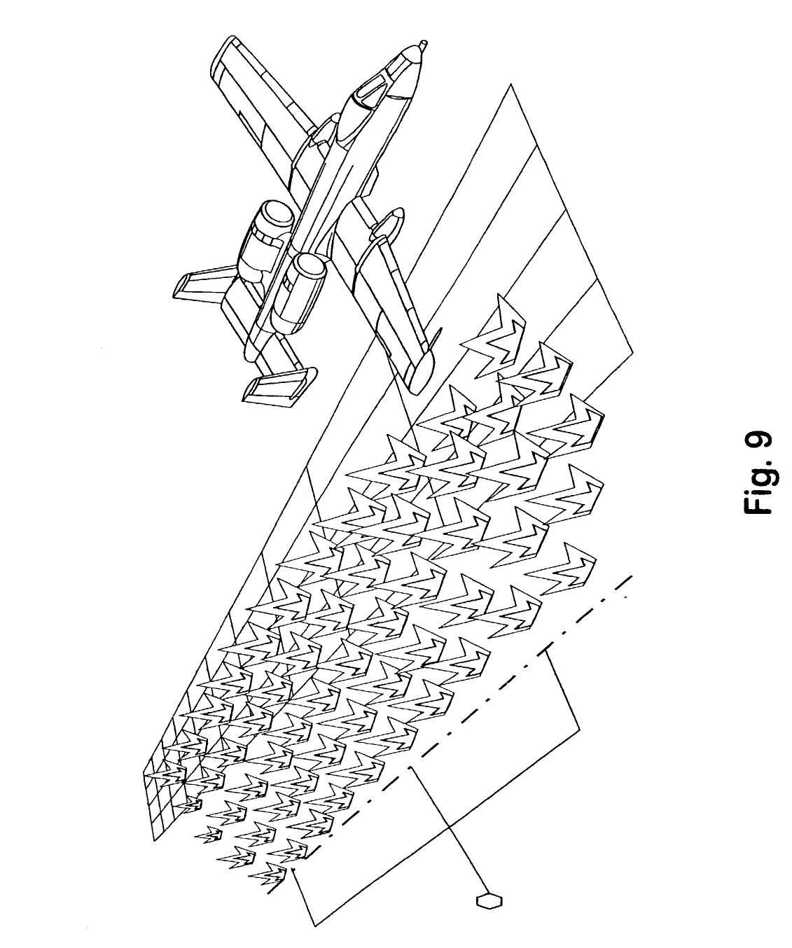

FIGS. 9, 10 and 11 illustrate yet further embodiments in which the area denial means is delivered by an aircraft;

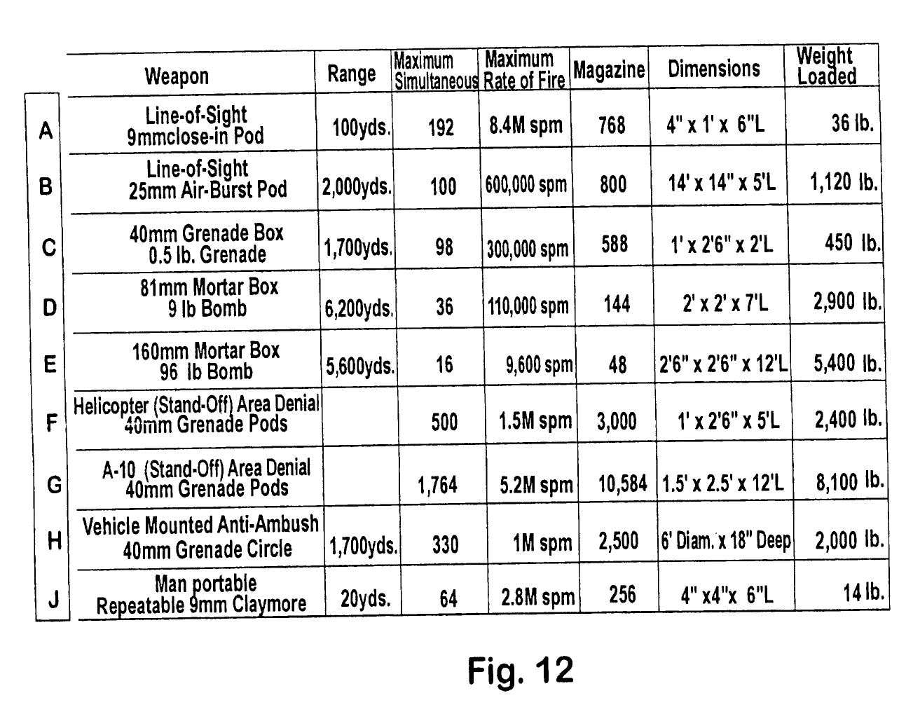

FIG. 14 is a table listing different weapon types and their relevant criteria.

Referring initially to FIGS. 1 and 2, it will be seen that a designated area 10 to be defended is monitored by an array of field sensors 11 distributed over the designated area and which may be of any suitable type such as pressure, acoustic or seismic type sensors. The sensors may be distributed by being delivered as projectiles from an electronic multi-round barrel remote from the designated area.

The defence module 12 is in the form of a pair of grenade boxes 13 each of which is substantially identical and coupled to a remote sensing means 14 which in this embodiment is tower mounted and adapted to sweep the designated area 10 to monitor any presence in the designated area such as by personnel or vehicles.

The sensing means 14 is adapted to receive signals from the array of field sensors 11 monitoring respective zones such that upon any such intrusion into the designated area, the zone of the intrusion will be registered and isolated for targeting by grenades fired from the grenade boxes 13.

It will be seen that each grenade box 13 is located in a substantially concealed position in the ground. When setting up the area denial means, the excavation in which the grenade box 13 is placed may be back filled to provide substantial concealment and stabilization of the weapon without causing any detrimental effect to the operation of the grenade box 13.

Typically the grenade box has an outer case in which the weapon is delivered to the front and which includes a lower casing portion 15 supporting the barrels 16 and which remains as an integral part of the weapon. An upper removable lid assembly 17, when removed, forms an adjustable base mounting for adjusting the trajectory and general direction of the grenades launched therefrom.

For this purpose screw jacks 18 or the like may be coupled between the base mounting 17 and the lower casing portion 16 to selectively control the trajectory of grenades fired therefrom. A turret type mounting may also be provided to enable the barrels 16 to be turreted for aiming purposes. Alternatively fold out adjustable legs may be utilised to support the grenade box 13 at the desired initial trajectory.

Typically the weapon illustrated contains 588 grenade carrying projectiles contained six to a barrel with the box containing a stack of 98 barrels in rows of side by side barrels. It is considered that such a box for 40 mm grenades would be in the order of 600 mm square in cross-section and 750 mm deep. If desired a larger box such as 700 mm square in section and 1 m long may be utilised, particularly if the larger calibre barrels are contained therein.

An alternate arrangement would be to provide a grenade box having a cluster of electronic multi-round 81 mm barrels containing heavy mortar rounds for defence against tanks and other vehicles together with a cluster of grenade launching electronic multi-round 40 mm barrels. The grenades could be used as anti-personnel rounds or fired in quick succession against a single target such as a vehicle. In such an arrangement a convenient size would contain 15×81 mm barrels each containing four heavy mortars and 50×40 mm barrels each containing six grenades. Various other calibres could be employed, such as 20 mm, 60 mm or 120 mm.

Suitably where large calibre rounds, such as 81 mm rounds are utilised they would be reduced in length compared to conventional rounds with a view to minimising the length of a barrel containing a plurality of such rounds stacked in line. For this purpose each trailing round may partly fit into a recess in the tail of its leading round, such that the length of the four-stack column is less than the combined length of four rounds. It may also be desirable to fit the shortened rounds with folding fins which deploy in flight to provide stability.

A small control circuit provided as a plug-in connection to the grenade box 13 is fitted on-site but not during transport so as to maintain safety of the weapon during transport. Once fitted, the weapon is armed and ready to fire in accordance with controls provided by the sensing means 14.

In use, if an intrusion into the designated area is detected at a zone, such as any one of the zones indicated as 20 to 29 in FIG. 2, the appropriate barrel 16 can be activated to fire one or more mortars or grenades into that particular zone. For this purpose, the barrels of the weapon may have an inbuilt aiming system providing sufficient variation for selection of any one of the target zones at a respective side of the designated area. Such an arrangement is illustrated in our co-pending patent application No. PQ 3843.

Alternatively the grenade boxes 13 may be such that in the operative range of say 1000 m to 1500 m the grenades launched from the lower left hand tubes or barrels will reach the near left hand corner of the designated area. The grenades launched from upper left hand barrels will reach the far corner of the designated area and those launched from the corner barrels at the right hand side of the box will reach the near and far portions at the middle of the designated area.

In this manner, selected barrels can be activated to fire grenades to the desired zone. For this purpose, the barrels can be disposed with their axes parallel or splayed to achieve the desired target impact pattern.

From the above it will be seen that if desired, all barrels may be simultaneously activated to fire one round so that all of the designated area is shelled with grenades. Alternatively, one grenade may be fired to any zone in which a presence is detected. Then again, that zone or all zones may be subject to any selected number of grenades up to the six contained in each barrel. If desired, all of the grenades may be despatched to each or all of the designated zones in a fraction of a second.

The grenade boxes 13 utilise the inventions disclosed in my previous International Patent Application which provides simple and effective means of stacking multiple electrically fired projectiles in individual or groups of barrels, being free of feed or ejection systems or any mechanical operation.

The grenade boxes may be buried just below the ground or their upper end may be open and concealed by suitable camouflaging. Ingress of water or other contaminants into the backfill or the hole into which the grenade box is located will not affect the operation of the grenade box.

Thus it will be seen that such grenade boxes can be quickly deployed in a war one and connected to on-site or remote sensors to provide a hands free defended zone which will perform the functions of a minefield without having the disadvantage of remaining permanently after the defence is not required. In this respect, at any time the grenade boxes may be easily removed as a unit when not required.

Correspondingly, they may be easily replaced and if desired, a plurality of grenade boxes may be located in each site such as in a trench with suitable controls to have them fire in series so that after one grenade box 13 is depleted of its grenades, the next is activated.

Furthermore, if desired, the leading rounds of a grenade box may contain sensors which are fired upon installation of the grenade boxes so as to locate the infield sensors in the actual position to which the grenades will be fired from that barrel. Thus, designated areas may be with an array of field sensors for subsequent activation of the remaining rounds of the particular or associated grenade boxes.

In the embodiment illustrated in FIG. 3, the grenade boxes are replaced by banks of weapons 30 which are configured as kinetic close range solid state gun systems and which in the illustrated embodiment, fire 9 mm rounds across the designated area.

In the embodiment illustrated in FIG. 4, the weapons 40 fire air burst 25 mm rounds onto the target zones. The air burst rounds are adapted to explode at a low level above the ground such as at about 1 m to 3 m.

Of course, the grenade boxes 13 may be used in combination with the kinetic rounds, air burst rounds or other special purpose rounds so as to suit the particular situation which may have varying terrain and include bodies of water and in such instances, the type of round can be selected to suit the particular zone.

Additionally, the weapons can be carried on a vehicle such as a wheeled vehicle 50 in FIG. 5 or a tracked vehicle 60 in FIG. 6. In the wheeled vehicle 50, a grenade box 13 is supported on the tray of the utility while the roof supports the target acquisition sensors 51 and grenade dispensers 52 fire horizontally from the roof of the vehicle 50.

According to a further embodiment which could be particularly suited to defending an area such as the perimeter of an airfield or the like, such as illustrated in FIG. 7, the designated area contains permanent in-ground launching cases 70, each of which is adapted to receive removable inserts 71 of multiple projectile barrels to suit the particular purpose. For example, the projectiles may contain air burst grenades adapted to explode several metres above the ground for use as antipersonnel defences. Alternatively, the projectiles may be adapted to explode at a higher level for anti-aircraft defence. Preferably the in-ground cases are installed permanently and are armed or disarmed as required by inserting or removing the removable barrel insert. Suitably each in-ground case includes transmission means for remote control of an inserted barrel.

Additionally, in this embodiment, as in the earlier embodiment, manned stations may be provided to override the automatic controls and as illustrated in FIG. 8, the ground control may have a screen 80 for video surveillance cameras which monitor the designated area and suitable control means 81 which enables an operator to highlight the visible area in the screen where troops or vehicles are intruding for automatic firing of the barrel which will target those areas.

As illustrated, the screen may include rate of fire, area of fire, density of fire and duration of fire or other controls such as type of round to be despatched to the targeted zone.

Furthermore, the rounds may be delivered from pods supported by aircraft provided with remote control from the minefield sensors such that a manned or unmanned aircraft may deliver the grenades or other rounds to the target zone indicated by the monitoring means.

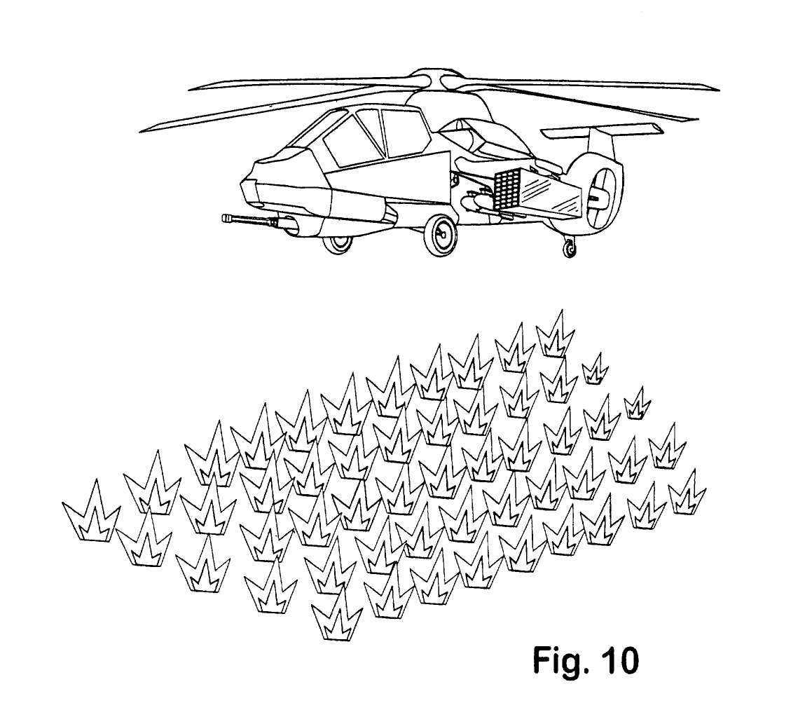

FIGS. 9 and 10 illustrate how a plane and/or a helicopter may be used to support the weapons for discharging a fixed array of rounds onto a target zone.

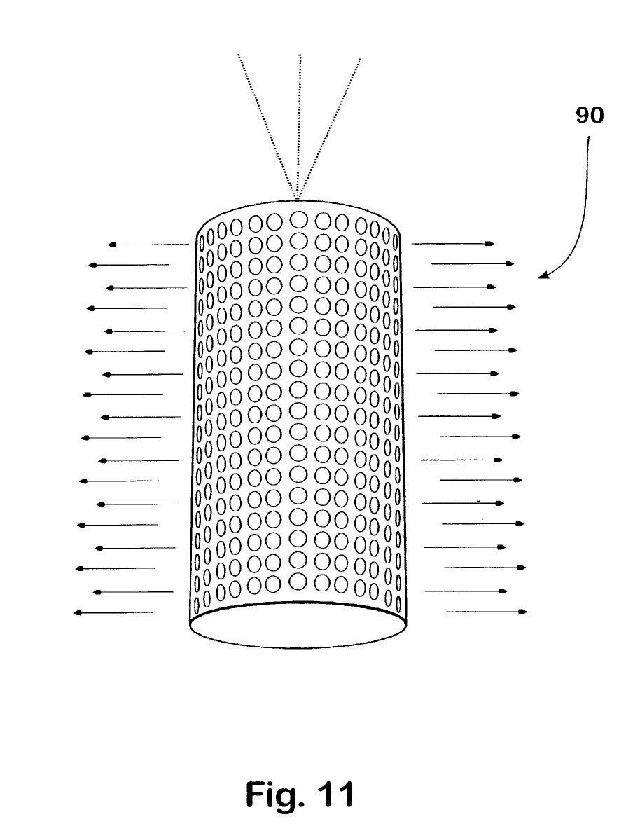

Alternatively, as illustrated in FIG. 11, the grenade box 90 may be of a cylindrical form provided with barrels radiating from a central control core which may be either mounted on the ground or dropped by a parachute but again with control from the monitoring means so that the rounds may be despatched to the designated target zone.

Each barrel assembly may have multiple grenade carrying projectiles of substantial known form loaded in rifled barrels to impart spin upon firing for activating the arming device. However the rupturable propellant cup is fixed to the projectile for flight therewith.

In use, as per my earlier inventions, loading of the projectiles forms wedge type seals at the leading and trailing ends of the sleeve 118 while firing releases the leading seal but maintains an operative seal at the rear end of the sleeve. The pressure projecting the projectile is normally less than 20,000 psi, which is much lower than allowable limits as shown by actual testing of our earlier inventions of this general barrel type.

FIG. 14 lists typical weapons which may be used with the present invention indicating range, the number of simultaneous rounds which may be despatched, the maximum rate of fire, the total number of rounds per weapon, the envisaged overall dimensions and envisaged overall weight.

It will of course be realised that the above has been given only by way of illustrative example of the invention and that all such modifications and variations thereto as would be apparent to persons skilled in the art are deemed to fall within the broad scope and ambit of the invention as is herein forth.

The claims defining the invention are as follows:

1. A method of denying access to a designated area wherein said method includes monitoring the designated area to detect the presence of an intruder, and initiating an attack on said intruder wherein said attack includes discharging projectiles from a barrel assembly, said barrel assembly having a barrel, a plurality of projectiles axially disposed within the barrel for operative sealing engagement with the bore of the barrel, and discrete propellant charges for propelling respective projectiles sequentially through the muzzle of the barrel.

2. A method according to claim 1 wherein the intruder is selected from the group consisting of military personnel, manned vehicles, unmanned vehicles or combinations thereof.

3. A method according to claim 1 wherein the designated area is monitored by sensors selected from the group consisting of on-site sensors remote sensors and combinations thereof.

4. A method according to claim 3 wherein the sensors are selected from the group consisting of visual, or infra-red detectors, radar and seismic sensors.

5. A method according to claim 1 wherein the projectiles are launched as direct or indirect fire.

6. A method according to claim 6 wherein the projectiles include an explosive charge.

7. A method according to claim 1 further including initiating a weapon affixed to a fixed object within the designated area wherein said weapon includes a plurality of barrel assemblies radially oriented from said fixed object and including a plurality of axially disposed projectiles.

8. An area denial system including a monitor for monitoring the designated area to detect the presence of an intruder, and ordinance for initiating an attack on said intruder wherein said ordinance includes a projectile launching apparatus for discharging projectiles from a barrel assembly, said barrel assembly having a barrel, a plurality of projectiles axially disposed within the barrel for operative sealing engagement with the bore of the barrel, and discrete propellant charges for propelling respective projectiles sequentially through the muzzle of the barrel.
